(19) United States
(12) Patent Application Publication
(10) Pub. No.: US 2010/0094881 A1
(43) Pub. Date: Apr. 15, 2010

(54) SYSTEM AND METHOD FOR INDEXING SUB-SPACES

(75) Inventors: Chad Brower, Campbell, CA (US); Ramana Yerneni, Cupertino, CA (US); Erik Vee, San Mateo, CA (US); Serguei Vassilvitskii, New York, NY (US); Jayavel Shanmugasundaram, Santa Clara, CA (US)

Correspondence Address: YAHOO! INC.;C/O Ostrow Kaufman & Frankl LLP, The Chrysler Building, 405 Lexington Avenue, 62nd Floor, NEW YORK, NY, 10174, US

(73) Assignee: YAHOO! INC., Sunnyvale, CA (US)

(21) Appl. No.: 12/242,748

(22) Filed: Sep. 30, 2008

(51) Int. Cl. G06F 17/30; G06Q 30/00; G06F 7/08

(52) U.S. Cl. 707/753; 705/14.4

(57) ABSTRACT

The present invention is directed to systems and methods for identifying compatible advertisement contracts to satisfy an advertisement opportunity. The systems and methods include receiving a number of attribute values associated with a user accessing a network-based location. The systems and methods include sorting an index of lists for a plurality of advertisement contracts on the basis of a number of contract term values. The systems and methods include traversing the index of lists to return a set advertisement contracts compatible with the number of attribute values associated with the user. The systems and methods include selecting a given advertisement contract from the set of advertisement contracts compatible with the number of attribute values associated with the user. The systems and methods include presenting an advertisement associated with the given advertisement contract on a display viewable by the user accessing the network-based location.

### COPYRIGHT NOTICE

A portion of the disclosure of this patent document contains material, which is subject to copyright protection. The copyright owner has no objection to the facsimile reproduction by anyone of the patent document or the patent disclosure, as it appears in the Patent and Trademark Office patent files or records, but otherwise reserves all copyright rights whatsoever.

### FIELD OF INVENTION

The present invention relates generally to advertising more specifically to the distribution of advertisements in a network-based environment.

### BACKGROUND OF THE INVENTION

Since the widespread acceptance of the Internet, advertising as a main source of revenue has proven to be both effective and lucrative. Advertising on the Internet provides the additional benefit of allowing advertisers to more effectively target audiences viewing their advertisements as opposed to traditional print and “hard copy” advertising which constitute a one-way flow of information: advertisers to users.

The very nature of the Internet facilitates a two way flow of information between users and advertisers and allows these transactions to be conducted in real time or near-to-real time. For example, a user may request an ad and may intentionally, or inherently, transmit various pieces of data describing himself or herself. Additionally, an advertising management system may be able to intelligently determine which ads to place on a given website requesting advertisement content, increasing the revenue for both parties involved and increasing user satisfaction by eliminating “nuisance” ads, or those ads in which a user is not interested.

The current state of the art, however, fails to fully exploit the interactive aspects of the Internet in the advertising realm. Most current advertising systems need to coordinate a number of components such as components for forecasting web traffic, targeting demographics, procuring ad placements and publishing ads. Each component relies on the cooperative and reliable performance of the others.

Unfortunately, current advertising systems are decoupled. A decoupled system results in a number of inconsistencies with respect to contracts for the placement and delivery of advertisements. Even just a slight overestimation of future web traffic may jeopardize an advertising system's ability to deliver the advertisements promised. Likewise, an underestimation hurts advertisers and publishers alike because of lost opportunities for ad placements.

Current systems create a strict and artificial separation between a display inventory of available advertisement placements, the inventory is sold many months in advance in a guaranteed fashion (guaranteed delivery), and an inventory that is sold using a real-time auction in a market or through other means (non-guaranteed delivery). For instance, the Yahoo! ®) advertising system may serve guaranteed contracts their desired quota before serving non-guaranteed contracts, creating an unnecessary and inefficient bias toward guaranteed contracts. While acceptable in the past, a shift in parts of the advertising industry reflects a mix of guaranteed and non-guaranteed contracts.

Another flaw with the decoupled advertising system is the failure to take advantage of the stores of information available when pricing contracts and allocating advertisements to advertisement placements. For example, the current pricing systems only use advertising information and contract information at a coarse and untargeted level. The failure to mine and use information regarding how advertisement placements may be allocated at a more granular level creates a gap between the price paid for an advertisement placement and the actual value that a contract derives from the advertisements placed.

This failure leads to the inability to provide more refined and targeted advertisements. Increased refinement in targeting allows advertisers to reach a more relevant customer base. The frustration of advertisers moving from broad targeting parameters (e.g., “1 million Finance users”) to more fine-grained parameters (e.g., “100,000 Finance users from September 2008-December 2008 who are California males between the ages of 20-35 working in the health care industry”) is evident. Unfortunately, the increased refinement and targeting is simply not computationally possible with the current system design.

Accordingly, there exists a need for a more unified marketplace and for a more effective way of identifying compatible advertisement contracts to satisfy an advertisement opportunity.

### SUMMARY OF THE INVENTION

The present invention is directed to system and method for identifying compatible advertisement contracts to satisfy an advertisement opportunity. The system and method includes receiving a number of attribute values associated with a user accessing a network-based location. The system and method includes sorting an index of lists for a plurality of advertisement contracts on the basis of a number of contract term values. The system and method includes traversing the index of lists to return a set of advertisement contracts compatible with the number of attribute values associated with the user. The system and method includes selecting a given advertisement contract from the set of advertisement contracts compatible with the number of attribute values associated with the user. The system and method includes presenting an advertisement associated with the given advertisement contract on a display viewable by the user accessing the network-based location.

### BRIEF DESCRIPTION OF THE DRAWINGS

The invention is illustrated in the figures of the accompanying drawings which are meant to be exemplary and not limiting, in which like references are intended to refer to like or corresponding parts, and in which:

FIG. 1 illustrates one embodiment of a system for identifying compatible advertisement contracts to satisfy an advertisement opportunity;

FIG. 2 illustrates a flowchart of one embodiment of a method for identifying compatible advertisement contracts to satisfy an advertisement opportunity;

FIG. 3 illustrates a sample output display as generated by the system and method for identifying compatible advertisement contracts to satisfy an advertisement opportunity.

### DETAILED DESCRIPTION OF THE EMBODIMENTS

In the following description, reference is made to the accompanying drawings that form a part hereof, and in which is shown by way of illustration specific embodiments in which the invention may be practiced. It is to be understood that other embodiments may be utilized and structural changes may be made without departing from the scope of the present invention.

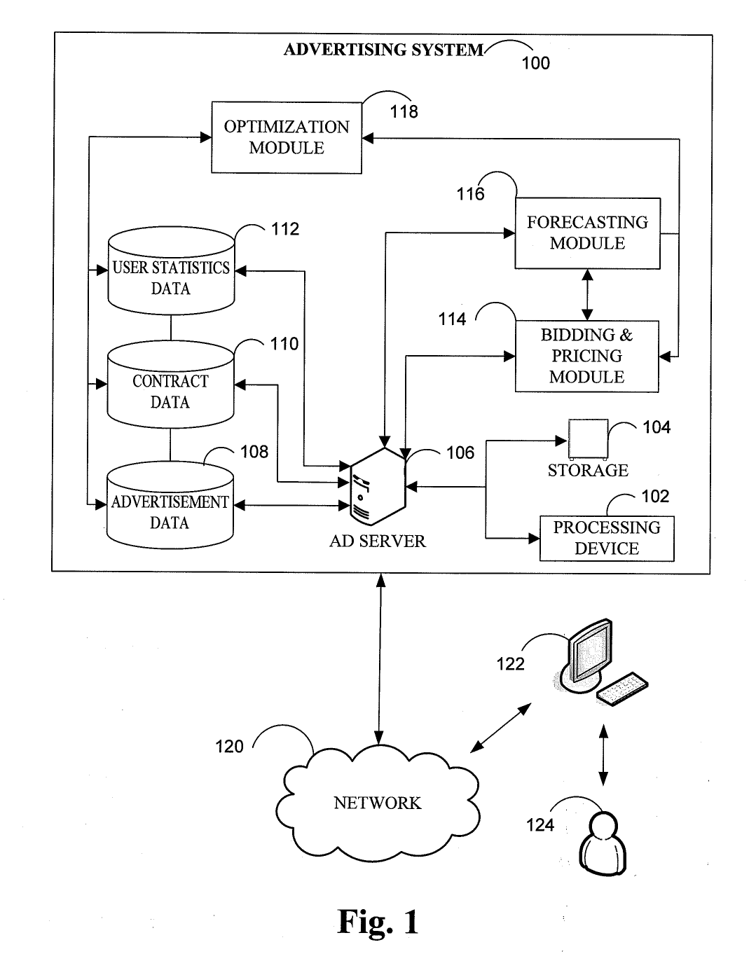

FIG. 1 illustrates an advertising system 100 including a processing device 102, a storage device 104 and an ad server 106. The advertising system 100 further includes an advertisement data store 108, a contract data store 110 and a user statistics data store 112. The advertising system further includes a bidding and pricing module 114, a forecasting module 116 and an optimization module 118. FIG. 1 also illustrates a network 120, a network-based output 122, and user 124.

The processing device 102 may be any suitable type of processing device operative to perform processing operations in response to executable instructions, wherein the executable instructions provide for processing operations as described in further detail herein. The storage device 104 may be any suitable type of storage device operative to store the executable instructions on a computer readable medium such that upon transmission to the processing device 102, the processing device 102 is operative to perform the processing operations as described herein.

The ad server 106 may be one or more server devices operative to perform server operations, including interfacing with the advertisement data store 108, the contract data store 110, the user statistics data store 112, the bidding and pricing module 114, the forecasting module 116 and an optimization module 118. The ad server 106 computer may be further operative to receive and transmit information over a network 120 to users 124 through the network-based output 122.

In one embodiment, the ad server 106 may be operative to establish and manage communication among and between a plurality of hardware devices, data stores, modules, networks, network-based outputs, and users. This communication may utilize communication protocols and/or techniques consistent with knowledge of one skilled in the art. In one embodiment, the ad server 106 may be a plurality server processing devices managing Internet connectivity between users, such as, for example a publicly available Internet search engine, where user 124 accesses a web site for search request operations.

In another embodiment, the ad server 106 may receive a query from an advertiser with contract terms specifying a target. For example, the query may specify Yahoo!® finance users who are California males with an interest in sports and autos. The ad server 106 may return the available advertisement placements for the specified target and a contract price. An advertiser may then book the contract through an interface presented on the network-based output 122. With the contract stored in the contract data store 110, the ad server 106 may receive an advertisement opportunity over the network 120. The advertisement opportunity may include a user, information about of the user, a URL of the webpage being accessed by the user and the like. The ad server 106 may then send an advertisement with the amount that the advertiser is willing to pay to the bidding and pricing module 114. The bidding and pricing module 114 may then determine to place the advertisement in the advertisement placement presented by the opportunity.

The advertisement data store 108 may include advertising information usable by the advertising system 100 for distributing advertisements to network-based outputs. The advertisement data store 108 may be any number of databases or data storage devices having advertising information stored therein. Advertising information may include, but is not limited to, an advertisement plan, advertisement content or media, advertisement metadata, advertiser information, publisher information, advertisement placements, advertisement opportunities and advertisement performance analytics. An advertisement placement may be the allocation of advertising space to a given advertisement contract. Additionally, the ad server 106 may include additional processing operations or procedures relating to the selection of particular ads and the placement of those ads in network-based outputs, wherein the selection of the particular advertisement may be aided by the processing operations of the processing device 102 in performing processing steps using information from any of the data stores 108, 110, 112 or modules 114, 116, 118 in communication with the advertising system.

The contract data store 110 may include contracting information usable by the advertising system 100, the contracting information relating to terms and conditions for the placement of a number of advertisement placements as requested by the advertiser. The contract data store 110 may be any number of databases or data storage devices having a plurality of contracts, contract requirements, marketing information, etc. Each contract stored in the contract data store may specify a number of attributes an advertiser may want to target. For example, a contract may specify a target as “Gender=Male, State=CA.” Then it will only be displayed to users that are both Male and from California.) Additionally, the ad server 106 may include additional processing operations or procedures relating to the procurement of advertisement placements consistent with the requirements of a given contract. For example, the additional operations or procedures may include receiving a contract time interval and targeting a demographic of users having defined characteristics.

The user statistics data store 112 may include user statistics information usable by the advertising system 100 in forecasting network traffic, traffic volume for users having defined characteristics, and associated advertising information. The user statistics data store 112 may be any number of databases or data storage devices having user information usable for various purposes, including predicting a volume of users having defined characteristics. Additionally, the ad server 106 may include additional processing operations or procedures relating to the periodic or dynamic updating of user statistics information, the addition of new users, network traffic, demographic and historical information.

The optimization module 118 may include any number of optimizing processes or procedures implemented in software or hardware, or a combination thereof. The optimization module 118 may be operative to receive information from and transmit information to the advertisement data store 108, the contract data store 110, the user statistics data store 108, and the ad server 106. Through the ad server. 106, the optimization module 118 may be placed in communication with users on a network-based output 122 through the network 120.

The optimization module 118 may be further operative to be in communication with the bidding and pricing module 114 as well as the forecasting module 116. When in communication with the forecasting module 116, the optimization module 118 may be operative to periodically or dynamically receive forecasting information comprising a number of future advertisement placements or impressions, actual contract information and a prediction of future contracts. The optimization module 118 may be further operative to process information for determining an advertising plan.

In one embodiment, an advertising plan comprises the allocation and distribution of advertisements to the advertisement placements predicted. A summary of the advertisement plan may be transmitted to the ad server 106 and to the bidding and pricing module 114. The advertisement plan may be updated periodically or dynamically on the basis of receiving additional forecasting information or additional information regarding network traffic. Given a plan, the ad server 106, upon receiving an advertisement opportunity may calculate the contention among contracts, to be described in more detail below. When used in combination with the forecasting information, information stored in data stores 108, 110, 112, and the contention information, the ad server 106 may select a contract and generate a bid for the contract in an effort to procure an advertisement placement presented by an advertisement opportunity.

In one embodiment, the advertising plan is periodically or dynamically updated and transmitted to the forecasting module 116, bidding and pricing module 114 and the ad server 106.

The forecasting module 116 may include any number of forecasting processes or procedures implemented as software or hardware, or a combination thereof. The forecasting module 116 may be operative to determine the current availability of advertisement placements given any number of parameters. Some of those parameters may include user characteristics, marketing information and contract time intervals. In one embodiment, the forecasting module 116 uses a scalable multi-dimensional database indexing technique, such as bit-map indexing, for capturing and storing correlations between any number of user characteristics.

The forecasting module 116 may be further operative to determine contention between multiple contracts in the contract data store 110. In one embodiment, the forecasting module 116 may generate a sample data set, for example, impression samples, to determine contention between contracts as well as the number of contracts that may be satisfied. Forecasting information may be communicated to any number of suitable locations, such as the optimization module 118, the bidding and processing module 114, or to users 124 through the network 120 for additional processing.

The bidding and pricing module 114 may include may include any number of processes or procedures implemented as software or hardware, or a combination thereof. The bidding and pricing module 114 may be in communication with the advertisement data store 108, the contract data store 110, the user statistics data store 112, the optimization module 118, the forecasting module 116, the ad server 106 or with any number of users 124 through the network 120.

In one embodiment, the bidding and pricing module 114 is operative to update advertiser bids and prices for advertisement placements, automatically or otherwise. In one example, the bidding and pricing module 114 automatically calculates and updates an advertiser's bid or the price for an advertisement placement at a fixed time interval. The bidding and pricing module 114 may also be operative to receive notification from the optimization module 118 to update bidding and pricing information in response to distributing an advertisement or receiving advertisement placement opportunity. In addition, the bidding and pricing module 114 may be operative calculate and update the bids or prices for advertisement placements to be presented to a user having defined characteristics.

The preceding updates may be in response to a change in a bid from another advertiser for the user having similar characteristics. The preceding updates may also be in response to a variance between forecasting information regarding user traffic or the volume of users having defined characteristics and the actual user traffic or volume of users as they are received by the advertising system 100.

The network 120 may include any communications network (e.g., a wired/wireless LAN/WAN, a cellular network, the Internet, an intranet, a social network, a VPN, a PSTN, a VoIP, etc.). The network-based location 122 may include a general purpose personal computer comprising a processor, transient and persistent storage devices, input/output subsystem and bus to provide a communications path between components comprising the general purpose personal computer. Other network-based locations are considered to fall within the scope of the present invention including, but not limited to, hand held devices, set top terminals, mobile handsets, PDAs, etc.

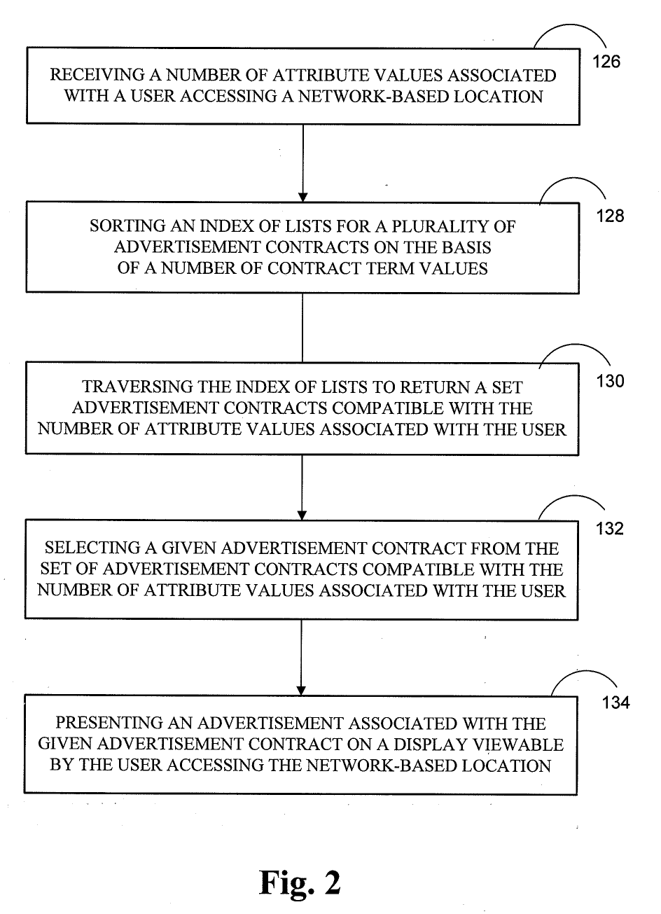

FIG. 2 illustrates a flowchart of one embodiment of a method for identifying compatible advertisement contracts to satisfy an advertisement opportunity. The method includes, step 126, receiving a number of attribute values associated with a user 124 accessing a network-based location 122. With reference back to FIG. 1, the advertising system 100 may receive user information when the user 124 goes online. For example, a user 124 may login to a myYahoo!® page where the advertising system 100 has a profile, a search history, a browsing history, bookmarks, receipts, an e-mail account, a subscription to RSS feeds, and an association with social networks or online groups.

In one embodiment, the advertising system 100 receives attribute values associated with the user 124 absent express permission from the user. For example, the user 124 may have an account with the default preferences set so profile information, including attribute values, may be automatically sent to the advertising system 100 as well as other systems on the network. In other embodiments, the user 100 may determine which, if any, attribute values the advertising system 100 may receive. In either embodiment, the advertising system 100 may receive the number of attribute values associated with a given user 124 as a list of attribute values. Some attribute values received may include, but are not limited to, a geographic attribute value, an age attribute value and a gender attribute value.

The next step is sorting an index of lists for a plurality of advertisement contracts on the basis of a number of contract term values, step 128. Prior to sorting, the advertising system 100 may create an index, or set of lists, based on the set of contracts received and stored in the contract data store 110. In one embodiment, the advertising system 100 may create a list for any possible attribute value. For example, the advertising system may create a list for “Gender=Male,” and that list would store contracts targeting males, even if the contract also specified other attribute values.

After creating the index of lists, the advertising system 100 may perform the step of sorting the index, step 128. In one embodiment, the advertising system 100 may group all of the contracts by how many attributes an advertiser specifies. For example, if a contract specifies “Gender=Male, State=CA”, the contract would be grouped into the list having contracts with two attributes. In this regard, the advertising system 100 may maintain a list for every attribute value/contract group. With this grouping, the advertising system 100 may create a separate list appending all the lists for a given attribute value, one after another. For example, the advertising system may create a list for “Gender=Male, 2 attributes total” and another list for “Gender=Male, 3 attributes total” and so on.

In another embodiment, the advertising system 100 runs a query for a list of contracts on the contract data store 110 of FIG. 1 or in any accessible data storage device. Upon receipt of attribute values, the advertising system 100 may cull attribute values not utilized for sorting the index of lists. Given an unsorted list, the advertising system 100 may sort by generating an index of lists. In one embodiment, the advertising system 100 sorts the index of lists by generating a separate list on the basis of the number of contract terms. Within the index of lists there may be a list of advertisement contracts that specifies one contract term and a second list for advertisement contracts specifying two contract terms and so on. A contract term may be a contract term type, including but not limited to, an age term, a gender term, a profession, a political affiliation and an interest.

In one embodiment, the advertising system 100 will return each list associated with user's attribute information. For example, if the user 124 is a Male from CA whose Age=20-25, the advertising system 100 may return the lists for “Gender=Male, 1 attributes total,” for “Gender=Male, 2 attributes total,” for “Gender=Male, X attributes total” (for X=3,4, . . . ), as well as the lists for “State=CA, X attributes total” (for X=1,2,3, . . . ), as well as the lists for “Age=20-25, X attributes total” (for X=1,2,3, . . . ).

When storing the lists, each element in the index of lists may have three values including a list identifier, the number of contract terms and a contract identifier. In one embodiment, the list of contracts having a larger number of contract terms appears at the beginning of the index while the list of contracts having a smaller number of contract terms appears at the end. In another embodiment, the advertising system 100 sorts the index of lists by generating a separate list on the basis of the types of contract terms. In yet another embodiment, the advertising system 100 stores a pre-sorted index of lists in the contract data store 110.

The next step is traversing the index of lists to return a set advertisement contracts compatible with the number of attribute values associated with the user 124, step 130. In one embodiment, the advertising system 100 traverses the index of lists for a given group first. For example, the advertising system may traverse the lists for “Gender=Male, 1 attributes total”, for “State=CA, 1 attributes total,” and for “Age=20-25, 1 attributes total.” In this regard, contracts encountered in any of these lists may be considered a match. The advertising system 100 may then traverse the lists for 2 attributes total: the list for “Gender=Male, 2 attributes total,” for “State=CA, 2 attributes total,” and for “Age=20-25, 2 attributes total.” For this group, contracts appearing in 2 lists may be considered a match. The advertising system 100 then continues with 3 attributes, 4 attributes, and so on.

In another embodiment, the advertising system 100 traverses the list comparing the number of contract terms with the number of attribute values associated with the user 124. If the number of contract terms associated with a contract is equal to or less than the number of attribute values associated with the user 124, it is possible to satisfy that contract. In this manner, an entire list of advertisement contracts having a number of contract terms higher than the number of attribute values associated with the user 124 may be removed from consideration. In one embodiment, the ad server 106 transmits the index of lists of compatible contracts to the optimization module 118 for further processing. This may significantly decrease the processing resources otherwise wasted in a linear scan comparing all the advertisement contracts term values with the attribute values associated with the user 124.

The next step, step 132, is selecting a given advertisement contract from the set of advertisement contracts compatible with the number of attribute values associated with the user. In one embodiment, the advertising system 100 maps a number of contract term types with the corresponding attribute types associated with the user. With that mapping, the advertising system 100 may compare contract term values with attribute values associated with the user 124 returning a set of advertisement contracts matching the attribute values associated with the user 124. Notably, it is not necessary for this matching to be identical. Given the potential variation of attribute values associated with the user, contract term values may be less specific. For example, a user 124 may have an attribute value indicating that user is a trader with a large banking firm where an advertisement contract may have a term specifying a user with an occupation in the finance industry as the contract term value.

Since more than one advertisement contract may match the attribute values associated with the user 124, the selection of a given contract may be based on a variety of factors. In one embodiment, the determinative factor may be the bidding price. In other embodiments, allocation algorithms may consider a variety factors in selecting a given contract. Upon selecting the given advertisement contract, the advertising system 100 may retrieve the advertisement associated with the given advertisement contract from an advertisement storage device such as the advertisement data store 108.

The next step is presenting an advertisement associated with the given advertisement contract on a display viewable by the user accessing the network-based location, step 134. With reference back to the embodiment illustrated in FIG. 1, the ad server 106 retrieves an advertisement from the advertisement data store 108 and transmits the advertisement over the network 120 for display to a user 124. A given advertisement may comprise any number of media formats, including but not limited to, text, image, audio and video. Thereupon, in the embodiment illustrated in FIG. 2, the method is complete.

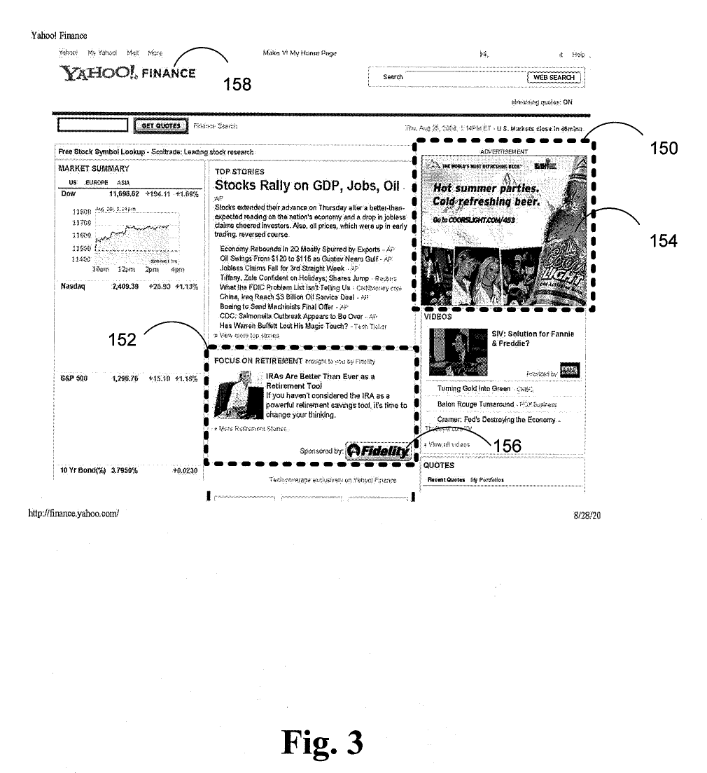

FIG. 3 illustrates a sample output display as generated by the system and method for identifying compatible advertisement contracts to satisfy an advertisement opportunity. The sample output display may be generated by the advertising system 100 of FIG. 1 for display on the computer 122 via the network 120. Prior to display, the advertising system 100 of FIG. 1 receives information about the user 124, sorts an index of lists for a plurality of compatible contracts, traverses the index of lists to return a set of advertisement contracts compatible with the information about the user 124 and selects a compatible advertisement contract. The advertising system 100 of FIG. 1 recognizes the selection of the compatible advertisement contract, such that the ad server 106 presents an advertisement associated with the selected advertisement contract on a display viewable by the user 124 accessing the network-based location 122.

The sample output display of FIG. 3 includes a first advertisement placement 150 and a second advertisement placement 152, denoted by the dotted lines. These advertisement placements are directed relative to the user 124. As the sample output display may suggest, the advertisements 154 and 156 may be placed in the advertisement placements presented to users having an interest in finance 158 and sports as defined characteristics. This sample output display generated includes one advertisement from Coors Light® 154 and another sponsored by Fidelity® 156, where the advertisement 154 recognizes that the user may choose a beverage for consumption while watching a sporting event and advertisement 156 which may to entice the user 124 to explore investment opportunities with their company. As such, the sample output display of FIG. 3 illustrates a representative display with advertisements selected based on the characteristics of the user and the fulfillment of corresponding advertisement contracts.

FIGS. 1 through 3 are conceptual illustrations allowing for an explanation of the present invention. It should be understood that various aspects of the embodiments of the present invention could be implemented in hardware, firmware, software, or combinations thereof. In such embodiments, the various components and/or steps would be implemented in hardware, firmware, and/or software to perform the functions of the present invention. That is, the same piece of hardware, firmware, or module of software could perform one or more of the illustrated blocks (e.g., components or steps).

In software implementations, computer software (e.g., programs or other instructions) and/or data is stored on a machine readable medium as part of a computer program product, and is loaded into a computer system or other device or machine via a removable storage drive, hard drive, or communications interface. Computer programs (also called computer control logic or computer readable program code) are stored in a main and/or secondary memory, and executed by one or more processors (controllers, or the like) to cause the one or more processors to perform the functions of the invention as described herein. In this document, the terms “machine readable medium,” “computer program medium” and “computer usable medium” are used to generally refer to media such as a random access memory (RAM); a read only memory (ROM); a removable storage unit (e.g., a magnetic or optical disc, flash memory device, or the like); a hard disk; electronic, electromagnetic, optical, acoustical, or other form of propagated signals (e.g., carrier waves, infrared signals, digital signals, etc.); or the like.

Notably, the figures and examples above are not meant to limit the scope of the present invention to a single embodiment, as other embodiments are possible by way of interchange of some or all of the described or illustrated elements. Moreover, where certain elements of the present invention can be partially or fully implemented using known components, only those portions of such known components that are necessary for an understanding of the present invention are described, and detailed descriptions of other portions of such known components are omitted so as not to obscure the invention. In the present specification, an embodiment showing a singular component should not necessarily be limited to other embodiments including a plurality of the same component, and vice-versa, unless explicitly stated otherwise herein. Moreover, applicants do not intend for any term in the specification or claims to be ascribed an uncommon or special meaning unless explicitly set forth as such. Further, the present invention encompasses present and future known equivalents to the known components referred to herein by way of illustration.

The foregoing description of the specific embodiments so fully reveals the general nature of the invention that others can, by applying knowledge within the skill of the relevant art(s) (including the contents of the documents cited and incorporated by reference herein), readily modify and/or adapt for various applications such specific embodiments, without undue experimentation, without departing from the general concept of the present invention. Such adaptations and modifications are therefore intended to be within the meaning and range of equivalents of the disclosed embodiments, based on the teaching and guidance presented herein. It is to be understood that the phraseology or terminology herein is for the purpose of description and not of limitation, such that the terminology or phraseology of the present specification is to be interpreted by the skilled artisan in light of the teachings and guidance presented herein, in combination with the knowledge of one skilled in the relevant art(s).

While various embodiments of the present invention have been described above, it should be understood that they have been presented by way of example, and not limitation. It would be apparent to one skilled in the relevant art(s) that various changes in form and detail could be made therein without departing from the spirit and scope of the invention. Thus, the present invention should not be limited by any of the above-described exemplary embodiments, but should be defined only in accordance with the following claims and their equivalents.

What is claimed is:

1. A method for identifying compatible advertisement contracts to satisfy an advertisement opportunity, the method comprising:
receiving a number of attribute values associated with a user accessing a network-based location;
sorting an index of lists for a plurality of advertisement contracts on the basis of a number of contract term values;
traversing the index of lists to return a set of advertisement contracts compatible with the number of attribute values associated with the user;
selecting a given advertisement contract from the set of advertisement contracts compatible with the number of attribute values associated with the user; and
presenting an advertisement associated with the given advertisement contract on a display viewable by the user accessing the network-based location.

2. The method of claim 1, wherein the attribute values are received absent permission from the user.

3. The method of claim 1, wherein the attribute value includes at least one of: a geographic attribute value, an age attribute value and a gender attribute value.

4. The method of claim 1 further comprising:
upon selecting the given advertisement contract, retrieving the advertisement associated with the given advertisement contract from an advertisement storage device.

5. The method of claim 1 further comprising:
upon receipt of attribute values, culling attribute values not utilized for sorting the index of lists.

6. A system for identifying compatible advertisement contracts to satisfy an advertisement opportunity, the system comprising:
a computer readable medium having executable instructions stored therein;
an index data store;
a processing device in communication with the computer readable medium and the index data store, the processing device receiving the executable instructions from the computer readable medium, the processing device, in response to the executable instructions, operative to:
receive a number of attribute values associated with a user accessing a network-based location;
sort an index of lists for a plurality of advertisement contracts on the basis of a number of contract term values;
traverse the index of lists to return a set advertisement contracts compatible with the number of attribute values associated with the user;
select a given advertisement contract from the set of advertisement contracts compatible with the number of attribute values associated with the user; and
present an advertisement associated with the given advertisement contract on a display viewable by the user accessing the network-based location.

7. The system claim 6 wherein the attribute values are received absent permission from the user.

8. The system claim 6 wherein the attribute value includes at least one of: a geographic attribute value, an age attribute value and a gender attribute value.

9. The system claim 6 wherein the processing device, in response to the executable instructions, is further operative to:
upon selecting the given advertisement contract, retrieve the advertisement associated with the given advertisement contract from an advertisement storage device.

10. The system claim 6 wherein the processing device, in response to the executable instructions, is further operative to:
upon receipt of attribute values, cull attribute values not utilized for sorting the index of lists.

11. Computer readable media comprising program code that when executed by a programmable processor causes execution of a method for identifying compatible advertisement contracts to satisfy an advertisement opportunity, the computer readable media comprising:
program code for receiving a number of attribute values associated with a user accessing a network-based location;
program code for sorting an index of lists for a plurality of advertisement contracts on the basis of a number of contract term values;
program code for traversing the index of lists to return a set advertisement contracts compatible with the number of attribute values associated with the user;
program code for selecting a given advertisement contract from the set of advertisement contracts compatible with the number of attribute values associated with the user; and
program code for presenting an advertisement associated with the given advertisement contract on a display viewable by the user accessing the network-based location.

12. The computer readable media of claim 11 wherein the attribute values are received absent permission from the user.

13. The computer readable media of claim 11 wherein the attribute value includes at least one of: a geographic attribute value, an age attribute value and a gender attribute value.

14. The computer readable media of claim 11 further comprising program code for:
upon selecting the given advertisement contract, retrieving the advertisement associated with the given advertisement contract from an advertisement storage device.

15. The computer readable media of claim 11 further comprising program code for:
upon receipt of attribute values, culling attribute values not utilized for sorting the index of lists.
